(19) United States
(12) Patent Application Publication
(10) Pub. No.: US 2016/0218915 A1
(43) Pub. Date: Jul. 28, 2016

(54) NETWORK CONFIGURATION APPLIANCE, METHOD AND SYSTEM

(71) Applicant: GD MUX TELECOM Inc., North Redington Beach, FL (US)

(72) Inventors: Ricky G Draper, North Redington Beach, FL (US); Adam Gallipeau, Southbridge, MA (US); Chris King, Charlton, MA (US); David Gagnon, Southbridge, MA (US)

(21) Appl. No.: 14/604,862

(22) Filed: Jan. 26, 2015

(51) Int. Cl. H04L 12/24; H04L 12/721

(52) U.S. Cl. CPC H04L 41/0803; H04L 45/14

(57) ABSTRACT

Embodiments of the present invention support unobtrusive remote management of a data center. In an embodiment of the invention, an appliance can be positioned within a data center and coupled both to the individual components in the data center's network and also to a wireless access point coupled to a cellular data modern. The appliance can provide a terminal services session to a remote client via the cellular data communications link. A network management application can execute in the appliance and can be configured to establish configuration parameters in the network's router. Configuration directives can be received from the remote computer through the terminal services session to establish configuration parameters in the router. The client's network can be remotely managed without requiring the manual configuration of the network internally to permit remote access through the firewall into the data center.

### BACKGROUND OF THE INVENTION

1. Field of the Invention

The present invention relates to setting up, maintaining and troubleshooting a computer data center and more particularly to a device, method and system that allow a skilled technician to do this securely and remotely.

2. Description of the Related Art

A data center is a collection of computing devices coupled to one another over a local communications network. These devices can include Central Processing Units (CPUs), data storage, file or applications servers, firewalls, switches, etc. The management of a data center often requires hands-on monitoring of the performance of different components in the data center, Continuous availability of the network is critical to users. If a failure occurs, the correct redundant system needs to be brought on line immediately and the source of the failure identified and repaired. The root cause of the failure might be complex and may require highly skilled expertise and specialized equipment to find. The present explosion of Information Technology (IT) needs by industry has led to a severe shortage of skilled individuals. To maximize efficiency, these individuals are frequently third party vendors who are called in in the initial provisioning of a system or when a complex failure occurs. The need for these individuals to physically travel to remote data centers and exclusively work on one problem at a tune is a highly inefficient use of a scarce resource.

The modem data center more often than not enjoys an external data communications linkage to the outside world through the global Internet by way of a firewall and router. Consequently, management of the data center can be performed locally by physically present personnel, or remotely through the Internet. However, configuring a firewall to permit such remote management is not always desirable. At the time of initial network set-up(provisioning), or during maintenance or troubleshooting, a static IP address is necessary to provide a stable connection for the technician to download patches or other software or access remote testing resources. Even when a company allows a trusted third party vendor to establish a communication link through their firewall, this creates an unacceptable security risk since, because it is static, others may be able to find it and use it to access the company's confidential data.

When a computer network is initially provisioned to provide new service to users, absent another pre-existing network, there is generally no existing internet connectivity available to that system and there will not be connectivity until that system is configured and brought on line. Many hardware and software systems must be installed, integrated and tested together to deliver new network services. Most provisioning is custom tailored to each installation because access rights and privileges for individual users of the various network resources have to be planned and implemented and legacy hardware and software must be integrated. The process of integration traditionally requires a skilled on-site installation technician to physically install software (including the operating system, device drivers, middleware and applications) and hardware to customize and configure the system to create or update a boot image for each server and then change its parameters, such as IP address and IP gateway to find associated network or storage resources to audit the system. System testing hardware and software may also be installed and/or accessed remotely and additional updates/patches may be required and most easily obtained via the Internet.

In the case where there is an existing corporate network in place and the new network is intended to supplement or eventually replace it, the on-site installation tech can connect to a remote source from behind the existing corporate firewall through Webex or similar means. However, the creation of a static IP address to enable a stable software transfer platform outside the client's firewall or through special configuration in the client's firewall creates the previously mentioned security concerns. In fact, creating any sort of interne connection is impossible in the case of a “green field” installation where, by definition, there are no other networks in place.

### BRIEF SUMMARY OF THE INVENTION

Embodiments of the present invention address deficiencies of the art with respect to computer data center provisioning, maintenance and troubleshooting and provide a novel and non-obvious device, system and method to achieve this. In an embodiment of the invention, a system comprising a wireless data plan modem, a computer and network switches connected to the various network components creates a static IP address separate from the client's network and allows a highly skilled technician to completely provision a new network, perform system maintenance or troubleshoot a client's network remotely without creating undue security risks for the client

In an embodiment of the invention, a method of data center remote management is provided. The method includes establishing a data communication network between different servers in a data center and a router communicatively linked to the global Internet. The method also includes attaching an appliance to the data communications network and wirelessly connecting the appliance to a cellular data modem. The method additionally includes establishing a communications path between the appliance and the global Internet separate from a communications path provided by the router through the data communications network. Finally, the method includes transmitting over the communications path provided by the cellular data modem a remote desktop from a terminal services session executing into the appliance and responding in the appliance to router configuration directives received through the remote desktop by configuring the router over the data communications network.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for data center remote management;

FIG. 2 is a schematic illustration of a data processing system configured for data processing management; and,

FIG. 3 is a flow chart illustrating a process for data center remote management.

### DETAILED DESCRIPTION OF THE INVENTION

Embodiments of the present invention provide for a novel and non-obvious method, system and computer program product enabled to support unobtrusive remote management of a data center. In accordance with an embodiment of the invention, an appliance can be positioned within a data center and coupled both to the individual components in the network of the data center which provide external communicative access by way of a router, and also to a wireless access point coupled to a cellular data modem. The appliance can provide a terminal services session to a remote client by way of a cellular data communications link provided by the cellular data modem. A network management application can execute in the appliance and can be configured to establish configuration parameters in the router. Configuration directives can be received from the remote computer through the terminal services session resulting in the establishment of the configuration parameters in the router. Also, an image of a user interface to the application including the configuration parameters of the router can be transmitted to a remote computing device for display therein through the terminal services session. In this way, remote management of the data center can he supported unobtrusively without requiring the manual configuration of the network internally to permit remote access through the firewall into the data center.

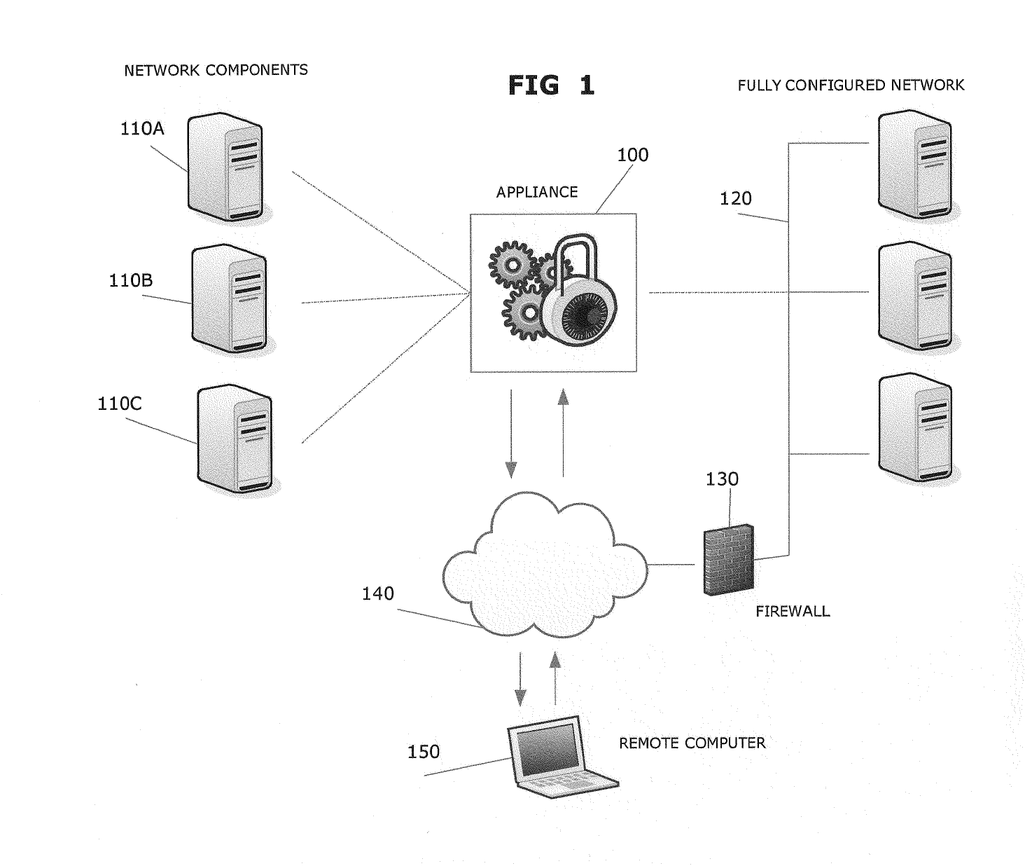

In further illustration, FIG. 1 pictorially shows a process for the remote management of a computer data center. As shown in FIG. 1, a Network Configuration Appliance 100 is connected to individual network components 110A-C which can include but are not limited to Central Processing Units (CPUs), data storage devices, file or application servers, firewalls, and switches. Appliance 100 independently communicates with a remote computer 150 using an internal wireless data modem through the global Internet 140.

The Appliance 100 receives system testing instructions, and other software instructions and software updates from remote computer 150 through the global Internet 140 and configures, provisions, updates and links individual network components 110A-C which results in a configured network 120. As part of the configuration, the Appliance 100 installs or repairs a firewall 130 in the configured network 120 between the configured network 120 and the global Internet 140.

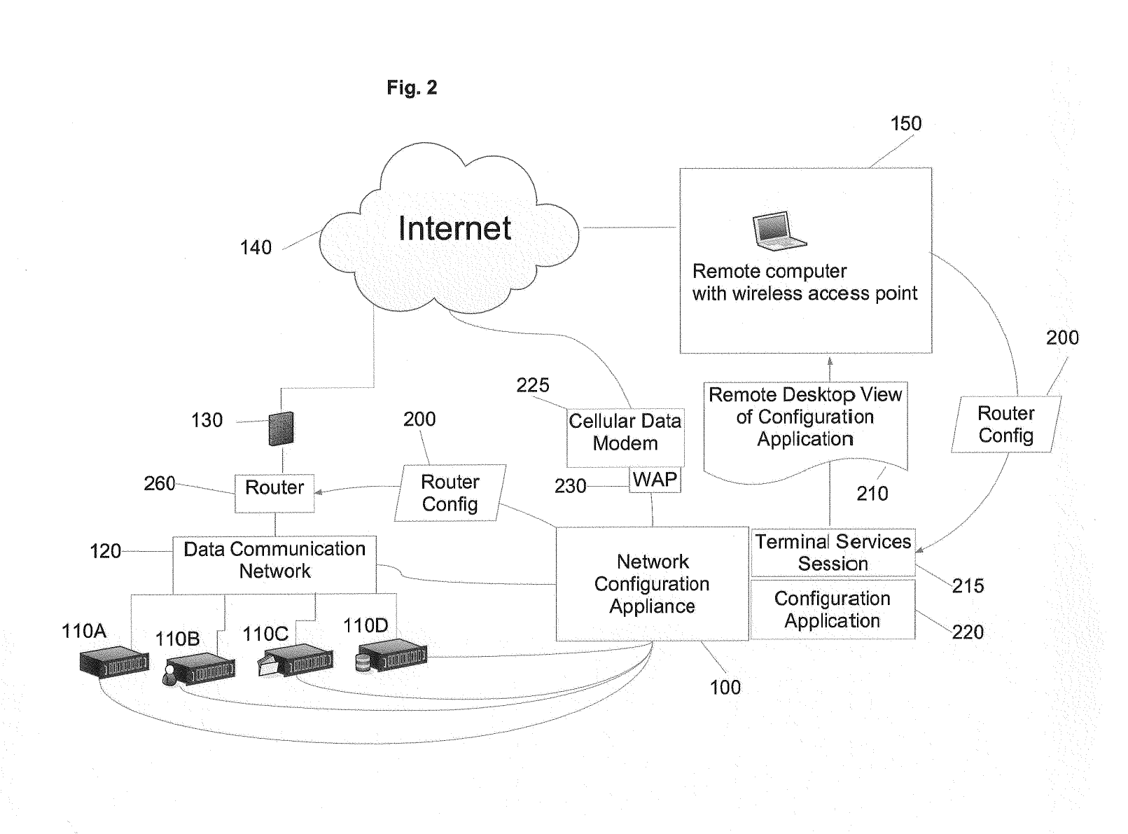

In further illustration, FIG. 2 shows a schematic illustration of a data processing system configured for data center remote management. A Network Configuration Appliance 100 is physically located at the site of the network 120 that is to be configured or repaired and through Wireless Application Protocol (WAP) 230 uses a Cellular Data Modem 225 to access the global Internet 140. The Network Configuration Appliance 100 is also connected to various network components 110A-D which include but are not limited to Central Processing Units (CPUs), data storage devices, file or application servers, firewalls, and switches. A Remote Computer with a wireless access point 150 communicates with the Network Configuration Appliance 100 while both are connected to the global Internet 140. The Remote Computer with a wireless access point 150 establishes a Terminal Services Session 215 on the Network Configuration Appliance 100 and through that creates a Remote Desktop View of the Configuration Application 210 on the Remote Computer with wireless access point 150. The Remote Computer with wireless access point 150 is then able to pass router configuration information 200 to the Network Configuration Appliance 100. The Network Configuration Appliance is thus able to remotely configure or repair the system or parts of the system including but not limited to: a new Data Communication Network 120, the

Router 260 that the new Data Communication Network 120 will use to access the Global Internet 140, and the Firewall 130 that protects the new Data Communication Network 120.

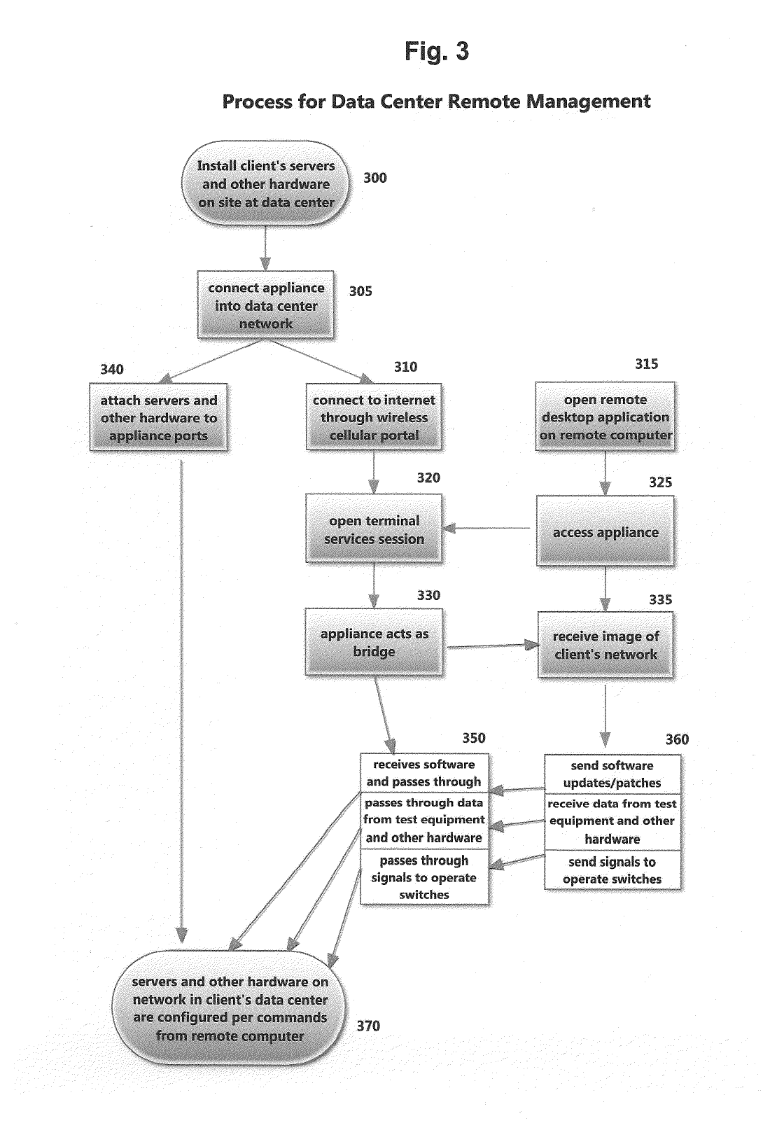

In even yet further illustration of the operation of the Network Configuration Appliance 100, FIG. 3 is a flow chart illustrating a process for Data Center Remote Management. Initially the client's servers and other hardware are installed on site at the client's data center and communicatively linked together 300. The Network Configuration Appliance is located at the client's site and communicatively linked into the data center network 305. The client's servers and other hardware are communicatively connected to the Network Configuration Appliance's ports 340. The Network Configuration Appliance is communicatively connected to the global Internet through a wireless cellular portal 310. A remote desktop application is opened on a remote computer 315 and, through the global internet, communicatively accesses the Network Configuration Appliance 325 and opens a terminal services session on the Network Configuration Appliance 320. The Network Configuration Appliance acts as a bridge 330 enabling the remote computer to receive images of the client's network 335.

The remote computer configures the client's network or repairs the client's network by performing various functions including but not limited to sending software updates/patches, receive data from test equipment on the client's network or other hardware and sending signals to operate switches in the client's network 360. The Network Configuration Appliance responds to router configuration directives from the remote computer via the wireless cellular portal and configures the client's network or repairs the client's network by performing various functions including but not limited to receiving and passing through software and data to network components, passing data from test equipment and other hardware on the client's network and passing through signals to operate switches in the client's network 350. The servers and other hardware on the network in the client's data center are configured per the commands from the remote computer 370.

Aspects of the present invention are described herein with reference to flowchart illustrations and/or block diagrams of methods, apparatus (systems), and computer program products according to embodiments of the invention. it will be understood that each block of the flowchart illustrations and/or block diagrams, and combinations of blocks in the flowchart illustrations and/or block diagrams, can be implemented by computer readable program instructions.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A data center remote management system comprising:
a data center comprising one or more servers communicatively linked to each other through a data communication network;
a router providing a communicative coupling between the data communications network and the global Internet;
at least one router routing data between the data communications network from selected traffic originating in and the global Internet;
a network configuration appliance, the appliance comprising at least one processor, memory, persistent storage, and a wireless networking adapter;
a wireless access point, comprising a cellular modem establishing data communications over a cellular network to the global Internet, the access point, bridging the data communications over the cellular network with a wireless communication link to the wireless adapter of the appliance;
a configuration application executing in the memory of the appliance, the configuration application comprising program code enabled to receive an instruction to configure a parameter in the router and to apply the parameter to the router, as directed;
and,
a terminal server executing in the memory of the appliance, the terminal server providing a remote desktop on the appliance to a remote computer over the cellular communications network, the desktop providing a user interface to the configuration application through which the directive is received.

2. The system of claim I, wherein the configuration application comprises additional program code enabled to receive an instruction to configure a parameter in a firewall coupled to the router and to apply the parameter to the firewall, as directed.

3. The system of claim 1, wherein the configuration application comprises additional program code enabled to receive an instruction to configure a parameter in an email server executing in one of the servers and to apply the parameter to the email server, as directed.

4. A method of data center remote management comprising the steps:
establishing a data communication network between different servers in a data center and a router communicatively linked to the global Internet;
attaching an appliance to the data communications network;
wirelessly connecting the appliance to a cellular data modem and additionally establishing a communications path between the appliance and the global Internet separate from a communications path provided by the router through the data communications network;
transmitting over the communications path provided by the cellular data modem a remote desktop from a terminal services session executing into the appliance; and
responding in the appliance to router configuration directives received through the remote desktop by configuring the router over the data communications network.

5. A computer program product for data center remote management, the computer program product comprising a computer readable storage medium having program instructions embodied therewith, the program instructions executable by a device to cause the device to perform a method comprising:
establishing a data communication network between different servers in a data center and a router communicatively linked to the global Internet;
attaching an appliance to the data communications network;
wirelessly connecting the appliance to a cellular data modem and additionally establishing a communications path between the appliance and the global Internet separate from a communications path provided by the router through the data communications network;
transmitting over the communications path provided by the cellular data modem a remote desktop from a terminal services session executing in the appliance; and
responding in the appliance to router configuration directives received through the remote desktop by configuring the router over the data communications network.
